(19) United States
(12) Patent Application Publication
(10) Pub. No.: US 2026/0300573 A1
(43) Pub. Date: Oct. 1, 2026

(54) METHOD FOR DETERMINING MASS PROPERTIES OF A BALL-AND-ROD LATTICE

(71) Applicant: Siemens Industry Software Inc., Plano, TX (US)

(72) Inventors: Callum DURNFORD, Cambridge (GB); James ETTLE, Cambridge (GB); Diana COX, Cambridge (GB); Matthew GODDARD, Cambridge (GB); Richard COLLINS, Cambridge (GB)

(21) Appl. No.: 19/478,651

(22) PCT Filed: May 12, 2023
(86) PCT No.: PCT/US2023/022057

§ 371 Date: Oct. 24, 2025

(51) Int. Cl. G06F 30/20

(52) U.S. Cl. CPC G06F 30/20

(57) ABSTRACT

A method for determining a mass property of a rod and ball lattice includes: determining the mass property for each ball in the lattice; determining, for each rod, the mass property of a portion comprising the inter-body volume between the terminal balls of the rod; generating an initial estimate of the mass property for the lattice based on the mass properties of the balls and portions of the rods; and, for each ball, identifying overlapping portions between pairs of rods that terminate at the ball, estimating the mass property for each identified overlapping portion, and modifying the initial estimate of the mass property of the lattice based on the estimation of the mass properties of the overlapping portions.

The present patent document is a § 371 nationalization of PCT Application Serial No. PCT/US2023/022057, filed May 12, 2023, designating the United States, which is hereby incorporated by reference in its entirety.

### TECHNICAL FIELD

The present disclosure relates to a computer implemented method for determining a mass property of a lattice in a three-dimensional model.

### BACKGROUND

Computer-Aided Design (CAD) systems are used in many fields of engineering, manufacturing, and design to create and manipulate solid modelling representations of objects, for example, in additive manufacturing. Additive manufacturing is the process of creating three-dimensional objects using a three-dimensional printer based on CAD or other digital three-dimensional models. Objects may be scanned as a precursor to creating a CAD model, or may be designed from scratch, and stored in either stereolithography file format (STL) or additive manufacturing file format (AMF) files for future printing.

Lattices are a common type of interior space-filler used in CAD systems and additive manufacturing. Lattice structures may be used for their physical and mechanical properties in, for example, heat transfer, filtration, and structural components. In Boundary Representation (B-rep) modelling, lattice structures may be enclosed by closed, connected sets of faces, where each face is a portion of a two-dimensional surface. The faces have boundary edges, which are defined by curves where the faces intersect with one another.

Rod and ball lattices are lattices comprising a plurality of lattice topologies, where a lattice topology is either a rod or a ball. Rods may be cylindrical or conical, and balls are spherical. Each rod is joined to other rods by a ball, building up the lattice structure. The ball radii may be constant across the lattice, or vary across the entire lattice, or a combination of both. Similarly, the rods may vary in thickness linearly along their length. However, both rods and balls may only exist within the lattice in their entirety, meaning that a lattice cannot contain a portion of a ball, and all rods are terminated by balls.

In modelling applications, it is desirable to be able to efficiently determine properties of lattices. Quantities such as surface area, volume, center of mass, and inertia, also referred to herein as mass properties, are particularly important in many real world applications to understand the physics of a modelled object. The control and estimation of error margins in mass property computation is also important as it allows a user to specify the degree of trade-off between computational accuracy and effort, and to have a quantitative appreciation of the accuracy of a result. In the context of a complete boundary representation model, lattice geometry may be contained within certain regions. To compute how a lattice region contributes to the mass properties of the larger model, how the lattice is trimmed by the boundaries of this region is taken into account.

Meshing may be used to compute mass properties of a modelled object. A mesh is a subdivision of a continuous geometric space into discrete geometric and topological cells called facets. In relation to lattices, mass properties may be determined by extracting a mesh representation of the lattice and then computing the mass properties of the mesh.

Unfortunately, for the purpose of computing its mass properties, meshing an entire lattice does not scale efficiently as the number of rods and balls in the lattice increase. Furthermore, the interaction of large numbers of rods and balls may affect the complexity of the mass properties calculation. It would therefore be desirable to be able to compute the mass properties of a lattice in a way that scales efficiently with the number of rods and balls and with sufficient accuracy and robustness, even as the degree of interaction between lattice elements grows.

### SUMMARY

It is an object of the disclosure to provide a method for determining a mass property of a lattice in a three-dimensional model.

The scope of the present disclosure is defined solely by the appended claims and is not affected to any degree by the statements within this summary. The present embodiments may obviate one or more of the drawbacks or limitations in the related art.

According to a first aspect, a method is provided for determining a mass property of a lattice comprising a plurality of rods and balls. The method comprises: determining the mass property for each ball in the lattice; determining, for each rod, the mass property of a portion comprising the inter-body volume between the terminal balls of the rod; generating an initial estimate of the mass property for the lattice based on the mass properties of the balls and portions of the rods; and, for each ball: i) identifying overlapping portions between pairs of rods that terminate at the ball; and ii) estimating the mass property for each identified overlapping portion; and modifying the initial estimate of the mass property of the lattice based on the estimation of the mass properties of the overlapping portions.

The method according to the first aspect enables the mass properties of a rod and ball lattice to be calculated efficiently. The method takes advantage of specific properties of certain types of lattice structures to improve performance and accuracy of the overall mass property calculation.

In a first implementation form, the mass property is surface area, mass, volume, center of gravity, or moment of inertia.

In a second implementation form, estimating the mass property for each overlapping portion comprises: representing the mass property as a surface integral over the surface of the overlapping portion; subdividing the surface of the overlapping portion into a plurality of subregions; evaluating the surface integral over each of the subregions; and estimating the mass property for the overlapping portion based on the evaluation of the surface integral over each of the subregions.

In a third implementation form, subdividing the surface of the overlapping portion comprises generating a representation of the surface of each ball in the overlapping portion as a plurality of facets.

In a fourth implementation form, subdividing the surface of the overlapping portion comprises subdividing the surfaces of the rods in the overlapping portion into a plurality of parameterized subregions.

In a fifth implementation form, the method according to the first aspect comprises weighting the surface integral based on the number of overlapping rods in the subregions.

In a sixth implementation form, the method according to the first aspect further comprises identifying, one or more further overlapping portions of the lattice, estimating the mass properties for each of the further overlapping portions and modifying the initial estimate of the mass property of the lattice based on the estimation of the mass properties of the further overlapping portions.

In a seventh implementation form, the further overlapping portion comprises: a) a ball-ball intersection; b) a rod-ball intersection, wherein the ball is not a terminal ball of the rod; or c) a rod-rod intersection, where the first rod is non-adjacent with the second rod.

In an eighth implementation form, subdividing the surface of the overlapping portion into a plurality of subregions comprises generating a first subdivision of the boundary of the surface that extends outside of the overlapping portion and generating a second subdivision of the boundary of the surface that that is contained within the overlapping portion.

In a ninth implementation form, estimating the mass property for the overlapping portion based on the evaluation of the surface integral over each of the subregions comprises: generating a first value based on the first subdivision of the boundary, wherein the first value comprises an overestimate of the surface integral over the surface of the overlapping portion; generating a second value based on the second subdivision of the boundary, wherein the second value comprises an underestimate of the surface integral over the surface of the overlapping portion; and generating a third value based on the first value and the second value, wherein the third value comprises an estimation of an error for the mass property of the overlapping portion.

In a second aspect, a computer program is provided, wherein the computer program comprises code that, when executed by a data processing system, causes the data processing system to carry out the acts of any of the methods outlined above.

These and other aspects of the disclosure are apparent from the embodiment(s) described below.

### BRIEF DESCRIPTION OF THE DRAWINGS

For a more complete understanding of the present disclosure, and the advantages thereof, reference is now made to the following descriptions taken in conjunction with the accompanying drawings.

FIG. 1 is a schematic perspective illustration of a lattice, according to an example.

FIG. 2 is a cross-section view of a lattice, according to an example.

FIG. 3a is a cross-section view of a truncated cone, according to an example.

FIG. 3b is a cross-section view of a spherical half lens, according to an example.

FIG. 4a is a schematic perspective illustration of a lattice, according to an example.

FIG. 4b is a diagram showing regions of overlap of rods on a ball in a lattice, according to an example.

FIG. 5a is a schematic perspective illustration of a parameterized surface, according to an example.

FIG. 5b is a schematic perspective illustration of a surface, according to an example.

FIGS. 6a and 6b show a schematic perspective illustration of a lattice, according to an example.

FIGS. 7a to 7c show a schematic perspective illustration of a lattice, according to an example.

FIGS. 8a to 8c show a cubic lattice, according to an example.

FIG. 9 is a block diagram of a method for determining a mass property of a lattice, according to an example.

FIG. 10 shows a simplified schematic diagram of a computing system, according to an example.

### DETAILED DESCRIPTION

Example embodiments are described below in sufficient detail to enable those of ordinary skill in the art to embody and implement the systems and processes herein described. It is important to understand that embodiments may be provided in many alternate forms and may not be construed as limited to the examples set forth herein.

Accordingly, while embodiments may be modified in various ways and take on various alternative forms, specific embodiments thereof are shown in the drawings and described in detail below as examples. There is no intent to limit to the particular forms disclosed. On the contrary, all modifications, equivalents, and alternatives falling within the scope of the appended claims may be included. Elements of the example embodiments are consistently denoted by the same reference numerals throughout the drawings and detailed description where appropriate.

The terminology used herein to describe embodiments is not intended to limit the scope. The articles “a,” “an,” and “the” are singular in that they have a single referent, however the use of the singular form in the present document may not preclude the presence of more than one referent. In other words, elements referred to in the singular may number one or more, unless the context clearly indicates otherwise. It will be further understood that the terms “comprises,” “comprising,” “includes,” and/or “including,” when used herein, specify the presence of stated features, items, steps, operations, elements, and/or components, but do not preclude the presence or addition of one or more other features, items, steps, operations, elements, components, and/or groups thereof.

Unless otherwise defined, all terms including technical and scientific terms used herein are to be interpreted as is customary in the art. It will be further understood that terms in common usage may also be interpreted as is customary in the relevant art and not in an idealized or overly formal sense unless expressly so defined herein.

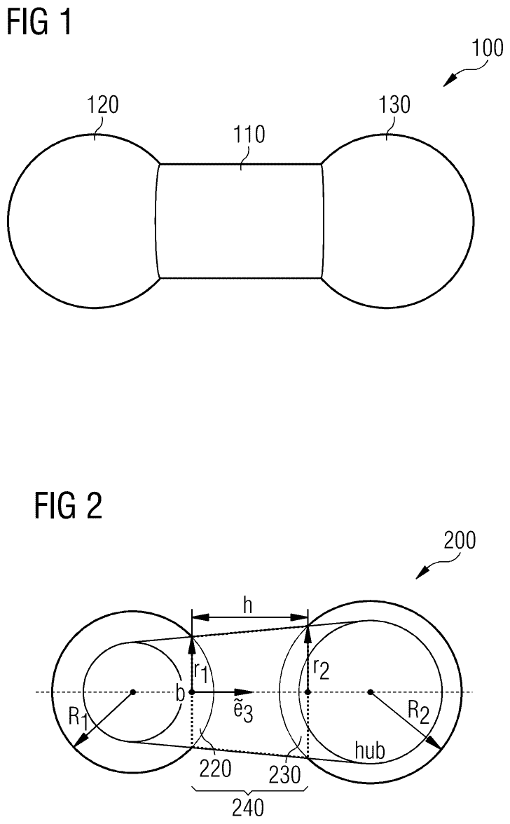

FIG. 1 is a schematic perspective illustration of a volumetric lattice 100, according to an example. The lattice 100 is an example of a simple ‘dumbbell’ shaped rod and ball lattice, comprising a cylindrical rod 110 with terminal balls 120, 130. In certain examples, the rods and balls that make up a lattice may be referred to as lattice bodies or lattice topologies. For a given ball, the rods which meet at the ball are said to be adjacent to each other and the ball. The other rods and balls in the lattice are said to be non-adjacent with each other. A self-intersection of a lattice is an intersection of a rod or ball with a non-adjacent rod or ball.

FIG. 2 shows a cross-sectional view of a lattice 200, similar to the lattice 100 shown in FIG. 1. The lattice 200 comprises a cone-shaped rod 210 and terminal balls 220, 230 of radii R₁ and R₂ respectively. The volume located between the balls 220, 230 comprising the portion of the rod 210, which is not inside either one of the balls 220, 230, is referred to herein as a dented rod 240. Geometrically, the dented rod 240 comprises a truncated cone with planar caps of radii r₁ and r₂ and length h with spherical half-lenses removed at each end.

Mass properties of simple lattices such as the lattices 100 and lattice 200, which do not have any body-body intersections, aside from the intersections of rods with their corresponding terminal balls, may be determined using classical geometry. In particular, the mass properties may be determined analytically from the classical equations for mass properties of spheres and truncated cones with half lenses removed. Starting with the balls, a sphere of radius R and center b, with assumed constant density ρ=1 has the following mass properties:

$$\begin{matrix}A = 4 π {R}^{2} & Area \\ V = \frac{4}{3} π {R}^{3} & Volume \\ G = b & Center of Gravity \\ {C}_{ij} = \frac{8}{15} π {R}^{5} {δ}_{ij} & Moment of Inertia\end{matrix}$$

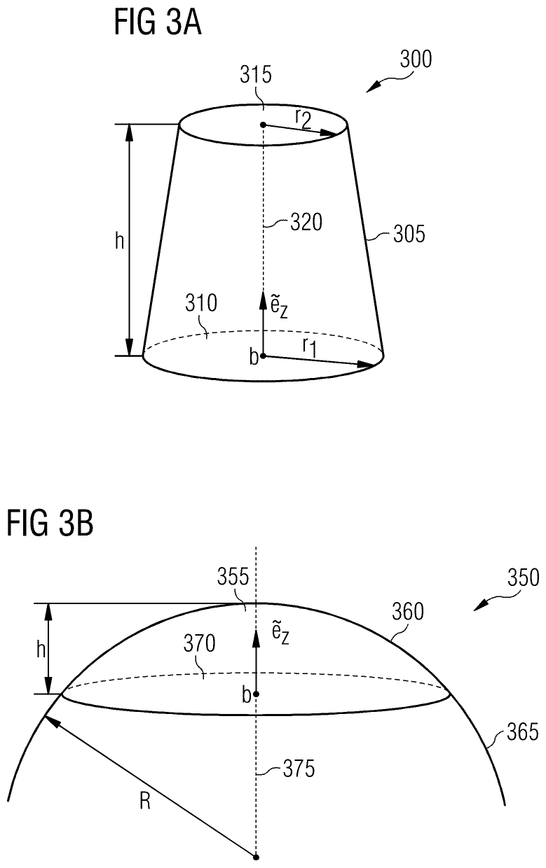

FIG. 3a is a cross-sectional view of a truncated cone 300 similar to the truncated cone of the volume 240. The truncated cone 300 is a conical solid 305 of length h with planar caps 310, 315 of radii r₁ and r₂, perpendicular to the cone axis 320. The base point b of the cone 300 lies in the cap of radius r₁. The body's frame {\tilde{e}ᵢ} is chosen such that \tilde{e}_{z} points along the cone's axis 320 from b towards the cap 315 of radius r₂. The area and volume of the truncated cone 300 are:

$${A}^{tc} ( h , {r}_{1} , {r}_{2} ) = π ( {r}_{1} + {r}_{2} ) \sqrt{{( {r}_{1} - {r}_{2} )}^{2} + {h}^{2}}$$

$${V}^{tc} = \frac{1}{3} π h ( {r}_{1}^{2} + {r}_{1} {r}_{2} + {r}_{2}^{2} )$$

Similarly, formulae for the center of gravity and moments of inertia about the principal axes may be determined as functions of b, \tilde{e}_{z}, h, r₁ and r₂.

FIG. 3b shows a cross-sectional view of a spherical half lens 350. This is the solid region 355 bounded by a spherical cap 360 of curvature radius R and a plane that cuts the sphere 365, such that the height of the cap 360 is h. The base point b is at the centre of the disc face 370, with the third element of the frame, \tilde{e}_{z}, pointing towards the cap 360 along the axis of symmetry 375. The area of the half lens spherical cap 360 and volume of the solid region 355 are:

$${A}^{hl} ( h , R ) = 2 π Rh$$

$${V}^{hl} ( h , R ) = \frac{1}{3} π {h}^{2} ( 3 R - h )$$

Similarly, formulae for the center of gravity and moments of inertia about the principal axes may be determined as functions of b, \tilde{e}_{z}, h and R.

The dented rod in lattice 200 shown in FIG. 2, may be characterized by the following value quantities:
h—the length of the truncated cone 240;
r₁, r₂—radii of the intersection between the truncated cone 240 and each of its balls 220, 230;
b—the centre of the intersection of the truncated cone 240 and ball 220;
{\tilde{e}ᵢ}—the body frame with \tilde{e}_{z}, pointing along the axis towards the ball 230;
R₁, R₂—radii of balls 220, 230.
The heights of the half lenses h₁, h₂ at balls 220, 230 are given by:

$${h}_{i} = {R}_{i} - \sqrt{{R}_{i}^{2} - {r}_{i}^{2}} .$$

The volumes of the individual component cone and half lenses are:

$${V}^{tc} = {V}^{tc} ( h , {r}_{1} , {r}_{2} )$$

$${V}^{hl ( i )} = {V}^{hl} ( {h}_{i} , {R}_{i} )$$

Combining all the equations, the volume and area of the dented rod 240 in FIG. 2 are:

$$A = {A}^{tc} - {A}^{hl ( 1 )} - {A}^{hl ( 2 )}$$

$$V = {V}^{tc} - {V}^{hl ( 1 )} - {V}^{hl ( 2 )}$$

In these equations, the cap areas of the half-lenses give a negative contribution as the entirety of the corresponding balls area is counted and subtracting the cap terms of the half lens correct for the region in the rod-ball intersection. Similar formulae may be determined for the center of gravity and moments of inertia for the dented rod, based on previously calculated quantities for volume, center gravity, and moments of inertia for the half lenses and truncated cone.

In some cases, a rod may be completely absorbed within its terminal balls. This may be treated as a dented rod with a truncated cone of zero length, e.g., an entirely negative contribution from the two subtracted half-lenses at the intersection of the balls.

In a simple lattice, in which there are no intersections other than rods with their terminal balls, the mass properties of the lattice may be determined exactly using the above equations. For example, for area and volume the areas and volumes of respective rods and balls may be summed:

$${A}^{LO} = \sum {A}^{( B )} + \sum {A}^{( D )}$$

$${V}^{LO} = \sum {V}^{( B )} + \sum {V}^{( D )}$$

In any lattice, these equations may be used in a first phase to give a leading order calculation for the mass properties of the lattice, which does not account for overlapping regions between rods and balls, aside from the overlap between rods and their corresponding terminal balls.

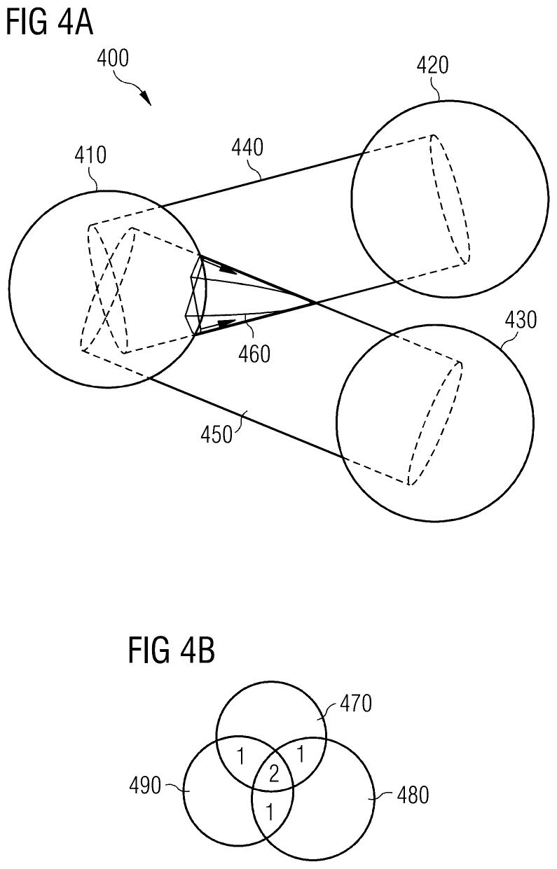

FIG. 4a is a schematic perspective illustration of a rod and ball lattice 400, according to an example. The lattice 400 comprises balls 410, 420, 430 and interconnecting rods 440, 450. The rod 440 connects balls 410, 420 and the rod 450 connects balls 410, 430. In other words, the ball 410 is a common terminal ball for rods 440, 450, and the rods 440, 450 are said to be adjacent to each other. Similarly, the ball 410 is adjacent to the rods 440, 450. In addition, the rods overlap in region 460. The region 460 is referred to herein as a duckbill region owing to the shape of the overlap between the rods 440, 450. The ball 410 and adjacent rods 440, 450 collectively may be referred to herein as a hub. In certain examples, the overlaps between rods at a given hub may be characterized by the circles of intersection on the surface of the ball of the hub.

FIG. 4b is a diagram showing the circles of intersection of three overlapping adjacent rods 470, 480, 490 on the surface of a ball. The numbers represent the degree of correction to the leading order mass property calculation. For example, the regions with a 1 correspond to a double overlap and the volumes of these regions may be subtracted once from the overall volume calculation. Similarly for the region labelled 2, where there is a triple overlap, the volume of this region may be subtracted twice from the overall volume calculation.

Using the divergence theorem, the volume P_{Ovlp}, of overlapping regions such as the region 460 in FIG. 4a, may be determined using the formula below, where the first integral is over the surfaces of the rods in the overlapping region, and the second integral is over the surface of the footprint of the rods on the ball in the overlapping region, similar to the region shown in FIG. 4b:

$${P}_{Ovlp} = {\int }_{{Cones}_{in overlap}} X ⊙ dS - {\int }_{{Footprint}_{on ball}} [ c ( x ) - 1 ] X ⊙ dS \qquad ( 1 )$$

In this formula, c(x) is a function c(x):

$${ℝ}^{3} \to {ℤ}_{0}^{+}$$

that takes a point in three-dimensional space and returns the number of rods in which the point lies including the rod boundary.

The integrals in equation (1) may be evaluated on a hub-by-hub basis. At a given hub, an adjacency matrix may be generated that records pair-wise clashes between rods in the hub. As previously described, the simplest case of a pair-wise overlap is the duckbill region 460 shown in FIG. 4a.

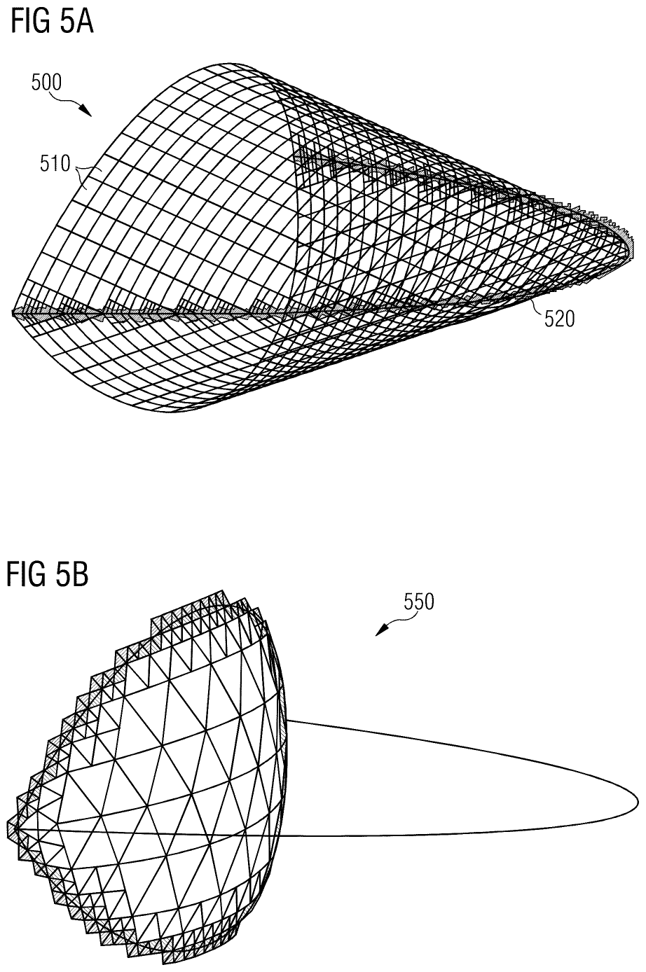

FIG. 5a shows a schematic perspective illustration of a parameterized surface 500, according to an example. The surface 500 comprises a subdivision of the surfaces of intersection of the rods 440, 450 in the duckbill region 460 into a plurality of parameterized patches 510. In the example shown in FIG. 5a, the parameter patches 510 are four-sided facets, herein referred to as quads. The quads are parametrically aligned to the principal curvatures of the surfaces they parameterize. The first integral in equation (1) may be determined in each quad in the region of overlap. As a quad is a parametric rectangle on a cone, the surface integral may be calculated exactly.

The contribution from parameter patches at the boundary 520 of the overlap region may be approximated by estimating a proportion of each patch that is inside the boundary region. The error incurred in this approximation may be modelled by also tracking the mass properties contribution from overestimating and underestimating this proportion. The parameter patches may be recursively subdivided in the neighborhood of the boundary. This enables the approximation to closely capture the true geometry of the overlap surface.

FIG. 5b shows a schematic perspective illustration of a surface 550, according to an example. The surface 550 comprises a faceted representation of the surface imprinted by the rods 440, 450 on the ball 410. Determining the local mass property contribution from the imprinted surface on the ball 410 is similar to the method used for the surface 500 except the surface 550 is faceted into a plurality of flat triangular mesh cells. This is efficient, and the extra approximation arising from using a faceted representation does not contribute significantly to the overall error. Once the contributions from the facets has been determined, then equation (1) may be used to determine mass property contributions for the entire overlap volume 460.

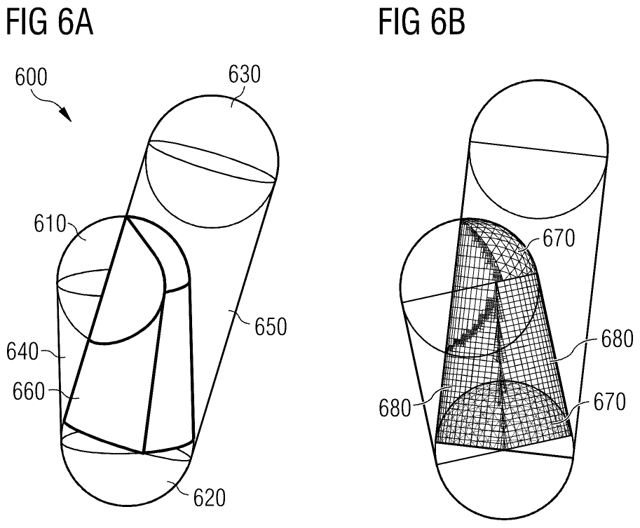

FIGS. 6a and 6b show a schematic perspective illustration of a volumetric rod and ball lattice 600, according to an example. The lattice 600 comprises balls 610, 620, 630 and interconnecting rods 640, 650. The rod 640 connects balls 610, 620 and the rod 650 connects balls 620, 630. The ball 620 is a common terminal ball for rods 640, 650. In addition, the ball 610, which is a non-terminal ball for the rod 650, intersects the rod 650 in the region of overlap 660.

The mass property calculations take into account the overlap of the ball 610 with the rod 650 in the region 660. The methods previously described may still be used in this case, to determine the mass properties of the lattice 600, even though there is an intersection between non-adjacent bodies of the lattice. In FIG. 6b, the surfaces 670 of the balls 610, 620 in the overlap region are faceted and the surfaces 680 of the rods 640, 650 are parameterized using quads, as previously described. Surface integrals may be evaluated over these subregions to determine the mass property contributions for the overlapping region 660.

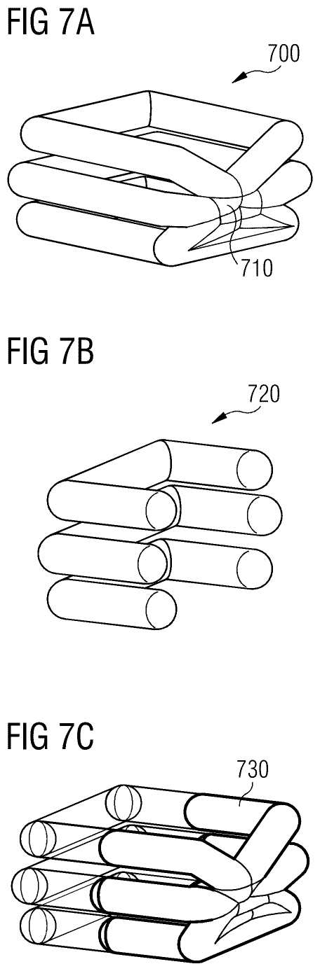

FIG. 7a shows a schematic perspective illustration of a volumetric rod and ball lattice 700, according to an example. The lattice 700 comprises a region 710 with multiple intersecting rods. The region 710 is too complex to be treated efficiently with the method previously described. Instead of trying to determine mass properties by evaluating surface integrals in sub-regions of the surfaces of the overlapping rods it is more efficient to divide the lattice into multiple sublattices.

FIGS. 7b and 7c show schematic perspective illustrations of the lattice 700 with new balls inserted to partition the lattice 700 into a collection of sublattices. A first collection of sublattices 720 is shown in FIG. 7b. The mass properties of sublattices 720 may be determined using the method previously described. These sublattices are simple lattices that do not contain any self-intersecting portions between non-adjacent lattice bodies.

In FIG. 7c, additional balls have been added to the remaining portion of the lattice 700, to form sublattice 730. The sublattice 730 comprises the non-trivially intersecting region 710. For sublattice 730, rather than attempting to use the method previously described, the mass properties of the sublattice 730 may be determined by incarnating the sublattice as a mesh and determining the mass properties of the mesh. Lattice incarnation for self-intersecting lattices may be performed efficiently using the techniques described in U.S. Pat. No. 12,411,998. This method is more efficient than incarnating the entire lattice 700 as a mesh.

In the context of a complete three-dimensional boundary representation model, lattice geometry may be contained within specific regions of the model. To compute how a lattice region contributes to the mass properties of a larger model, it is necessary to also take into account how the lattice is trimmed by the boundaries of this region.

The interaction of a lattice with its containing region is accounted for in a similar fashion to the lattice 700. Lattice elements that interact with the region boundary are identified, and new balls are inserted to partition the lattice into boundary sublattices, some of whose components meet the boundary, and internal sublattices which are disjoint from the region boundary. The inserted balls do not interact with the boundary as they need to be valid members of both the boundary sublattices and internal sublattices.

Internal sublattice mass properties may be calculated using the methods previously described, and boundary sublattice mass properties calculated using meshing techniques. All sublattice results are then appropriately accumulated, as in the final phase of the previously described methods, adjusting for overlaps at the inserted balls, to derive total mass property results for the overall lattice region.

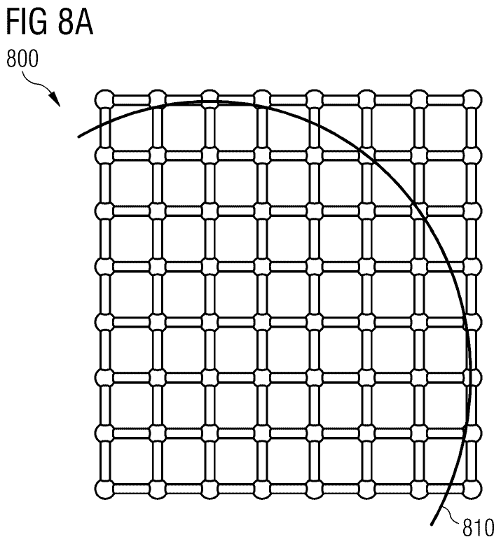

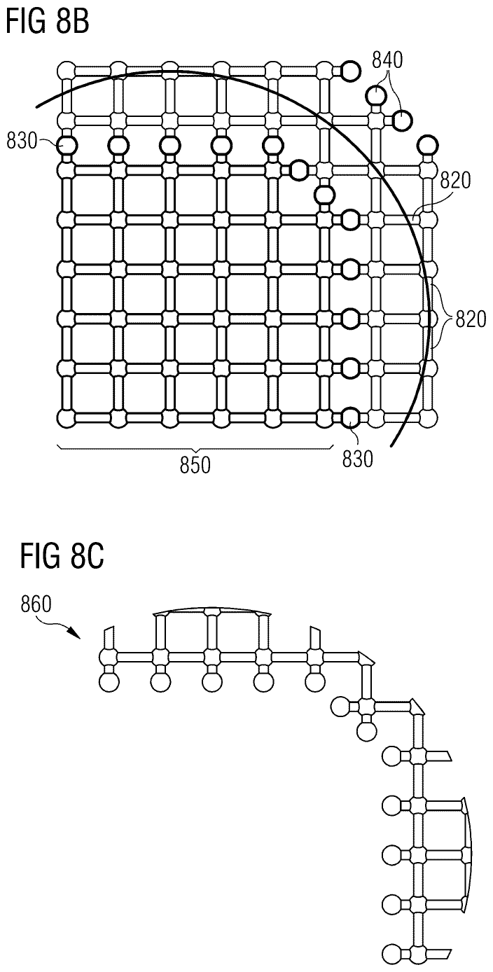

FIG. 8a shows a cubic rod and ball lattice 800, according to an example. The lattice 800 is embedded in a region with cylindrical boundary 810. FIG. 8b shows the same lattice 800 and boundary 810. Applying the method described herein, the lattice elements 820 that interact with the boundary 810 are identified. Additional balls 830, 840 are inserted to partition the lattice 800 such that elements 820, 830, 840 form a boundary sublattice. Elements 850 and balls 830 form an internal sublattice. FIG. 8c shows a mesh representation 860 of the boundary sublattice trimmed to the boundary 810. The mass property for the internal sublattice may be determined using the method described previously. The mass property of the mesh may be determined and combined with the mass property of the internal sublattice, adjusting for overlapping balls 830.

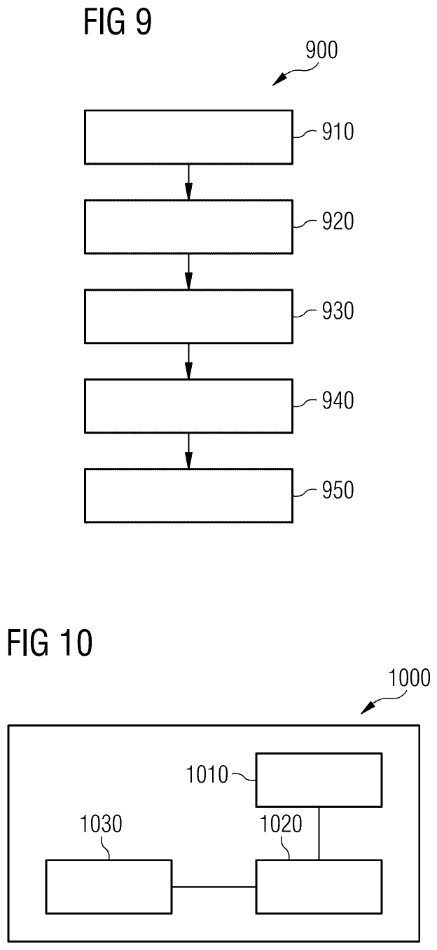

FIG. 9 shows a block diagram of a computer-implemented method 900 for determining a mass property of a lattice comprising a plurality of rods and balls, in a three-dimensional model. The method 900 may be used in conjunction with other methods described herein. The mass property may be the surface area, mass, volume, center of gravity or moment of inertia of the lattice.

At block 910, the method comprises determining the mass property for each ball in the lattice. According to examples, the mass property for each ball may be determined using classical formula as previously described.

At block 920, the method 900 comprises determining, for each rod, the mass property of a portion comprising the inter-body volume between the terminal balls of the rod. According to examples, the inter-body volume comprises a dented rod, similar to the dented rod 240 shown in FIG. 2.

At block 930, the method 900 comprises generating an initial estimate of the mass property for the lattice based on the mass properties of the balls and portions of the rods.

At block 940, the method 900 comprises, for each ball, identifying overlapping portions between pairs of rods that terminate at the ball and estimating the mass property for each identified overlapping portion. According to examples, estimating the mass property for each overlapping portion may comprise representing the mass property as a surface integral over the surface of the overlapping portion, subdividing the surface of the overlapping portion into a plurality of subregions, evaluating the surface integral over each of the subregions, and estimating the mass property for the overlapping portion based on the evaluation of the surface integral over each of the subregions.

At block 950, the method 900 comprises modifying the initial estimate of the mass property of the lattice based on the estimation of the mass properties of the overlapping portions.

The phased approach to mass property calculations described herein exploits specific properties of certain types of lattices to improve performance and accuracy of the calculation. Approximation is only used when necessary. This reduces error in comparison with other methods, while maintaining efficiency. For example, the analytic approach in the first phase of the calculation is very fast, and for a certain subclass of lattices this is sufficient to compute all mass properties exactly.

Similarly, for a wider class of non-self-intersecting lattices, the second phase based on surface integral calculations may be used to refine initial estimates from the phase one calculation, approximating the lattice in a manner sufficient to attain a user-specified accuracy. This may also be used to provide meaningful error estimates for each type of mass property. In both the first and second phase, the lattice data structure may be traversed in parallel threads of computation to speed up the overall calculation.

By using the more traditional mass properties approach for complex and boundary sublattices, the methods described herein provide robust behavior on complicated lattice regions, whilst still benefiting from the speed and accuracy-driven estimates of the first and second phase.

The present disclosure is described with reference to flow charts and/or block diagrams of the method, devices, and systems according to examples of the present disclosure. Although the flow diagrams described above show a specific order of execution, the order of execution may differ from that which is depicted. Blocks described in relation to one flow chart may be combined with those of another flow chart. In some examples, some blocks of the flow diagrams may not be necessary and/or additional blocks may be added. It shall be understood that each flow and/or block in the flow charts and/or block diagrams, as well as combinations of the flows and/or diagrams in the flow charts and/or block diagrams may be realized by machine readable instructions.

The machine-readable instructions may, for example, be executed by a general-purpose computer, a special purpose computer, an embedded processor or processors of other programmable data processing devices to realize the functions described in the description and diagrams. In particular, a processor or processing apparatus may execute the machine-readable instructions. Thus, modules of apparatus may be implemented by a processor executing machine-readable instructions stored in a memory, or a processor operating in accordance with instructions embedded in logic circuitry. The term ‘processor’ is to be interpreted broadly to include a CPU, processing unit, ASIC, logic unit, or programmable gate set etc. The methods and modules may all be performed by a single processor or divided amongst several processors.

Such machine-readable instructions may also be stored in a computer readable storage that may guide the computer or other programmable data processing devices to operate in a specific mode.

FIG. 10 shows an example 1000 of a processor 1010 associated with a memory 1020. The memory 1020 comprises computer readable instructions 1030 which are executable by the processor 1010.

The instructions 1030 cause the processor to determine a mass property of a lattice in a three-dimensional model. In particular, the instructions cause the processor to determine the mass property for each ball in the lattice, determine, for each rod, the mass property of a portion comprising the inter-body volume between the terminal balls of the rod and generate an initial estimate of the mass property for the lattice based on the mass properties of the balls and portions of the rods. The instructions further cause the processor to identify, for each ball, overlapping portions between pairs of rods that terminate at the ball and estimate the mass property for each identified overlapping portion and modify the initial estimate of the mass property of the lattice based on the estimation of the mass properties of the overlapping portions.

The present disclosure may be embodied in other specific apparatus and/or methods. The described embodiments are to be considered in all respects as illustrative and not restrictive. In particular, the scope of the disclosure is indicated by the appended claims rather than by the description and figures herein. All changes that come within the meaning and range of equivalency of the claims are to be embraced within their scope.

It is to be understood that the elements and features recited in the appended claims may be combined in different ways to produce new claims that likewise fall within the scope of the present disclosure. Thus, whereas the dependent claims appended below may depend on only a single independent or dependent claim, it is to be understood that these dependent claims may, alternatively, be made to depend in the alternative from any preceding or following claim, whether independent or dependent, and that such new combinations are to be understood as forming a part of the present specification.

1. A computer-implemented method for determining a mass property of a lattice in a three-dimensional model, the lattice comprising a plurality of rods and a plurality of balls, the method comprising:
determining a mass property for each ball of the plurality of balls in the lattice;
determining, for each rod of the plurality of rods, a mass property of a portion comprising an inter-body volume between terminal balls of the respective rod;
generating an initial estimate of the mass property for the lattice based on the mass properties of the plurality of balls and the mass properties of the portions of the plurality of rods;
identifying, for each ball of the plurality of balls, overlapping portions between pairs of rods that terminate at a respective ball;
estimating, for each ball of the plurality of balls, a mass property for each identified overlapping portion; and
modifying the initial estimate of the mass property of the lattice based on the estimation of the mass properties of the overlapping portions to provide a determined mass property of the lattice.

2. The method of claim 1, wherein the mass property is surface area, mass, volume, center of gravity or moment of inertia.

3. The method of claim 1, wherein, the estimating of the mass property for each overlapping portion comprises:
representing the mass property as a surface integral over a surface of the overlapping portion;
subdividing the surface of the overlapping portion into a plurality of subregions;
evaluating the surface integral over each subregion of the plurality of subregions; and
estimating the mass property for the respective overlapping portion based on the evaluation of the surface integral over each subregion of the plurality of subregions.

4. The method of claim 3, wherein the subdividing of the surface of the overlapping portion comprises generating a representation of a surface of each ball in the overlapping portion as a plurality of facets.

5. The method of claim 3, wherein the subdividing of the surface of the overlapping portion comprises subdividing surfaces of the rods in the overlapping portion into a plurality of parameterized subregions.

6. The method of claim 3, further comprising:
weighting the surface integral based on a number of overlapping rods in the plurality of subregions.

7. The method of claim 1, further comprising:
identifying one or more further overlapping portions of the lattice;
estimating mass properties for each further overlapping portion of the one or more further overlapping portions of the lattice; and
modifying the initial estimate of the mass property of the lattice based on the estimation of the mass properties of the one or more further overlapping portions of the lattice.

8. The method of claim 7, wherein a further overlapping portion of the one or more further overlapping portion comprises:
a ball-ball intersection;
a rod-ball intersection, wherein the ball is not a terminal ball of the rod; or
a rod-rod intersection between a first rod and a second rod, wherein the first rod is non-adjacent with the second rod.

9. The method of claim 3, wherein the subdividing of the surface of the overlapping portion into the plurality of subregions comprises:
generating a first subdivision of a boundary of the surface that extends outside of the overlapping portion; and
generating a second subdivision of a boundary of the surface that is contained within the overlapping portion.

10. The method of claim 9, wherein the estimating of the mass property for the overlapping portion based on the evaluating of the surface integral over each of the subregions comprises:
generating a first value, based on the first subdivision of the boundary, wherein the first value comprises an overestimate of the surface integral over the surface of the overlapping portion;
generating a second value based on the second subdivision of the boundary, wherein the second value comprises an underestimate of the surface integral over the surface of the overlapping portion; and
generating a third value based on the first value and the second value, wherein the third value comprises an estimation of an error for the mass property overlapping portion.

11. A computer-implemented method for determining a mass property for a lattice in a three-dimensional model, the lattice comprising a plurality of rods and a plurality of balls, the method comprising:
evaluating intersections between the plurality of rods and the plurality of balls;
subdividing the lattice into a plurality of sublattices based on the evaluation; and
determining a mass property for each ball of the plurality of balls in at least one sublattice of the plurality of sublattices;
determining, for each rod of the plurality of rods, a mass property of a portion comprising an inter-body volume between terminal balls of the respective rod;
generating an initial estimate of a mass property for the respective sublattice based on the mass properties of the plurality of balls and the mass properties of the portions of the plurality of rods;
identifying, for each ball of the plurality of balls, overlapping portions between pairs of rods that terminate at a respective ball;
estimating, for each ball of the plurality of balls, a mass property for each identified overlapping portion; and
modifying the initial estimate of the mass property of the respective sublattice based on the estimation of the mass properties of the overlapping portions to provide a determined mass property of the lattice.

12. The method of claim 11, wherein the subdividing of the lattice comprises:
identifying at least two self-intersections between a first lattice body and at least two further lattice bodies that are non-adjacent with the first lattice body; and
generating a sublattice comprising at least the first lattice body and lattice bodies adjacent to the first lattice body.

13. The method of claim 12, further comprising:
incarnating the sublattice as a mesh; and
determining the mass property for the mesh.

14. A non-transitory computer readable medium comprising a computer program having code that, when executed by a data processing system, causes the data processing system to:
determine a mass property for each ball of a plurality of balls in a lattice;
determine, for each rod of a plurality of rods in the lattice, a mass property of a portion comprising an inter-body volume between terminal balls of the respective rod;
generate an initial estimate of the mass property for the lattice based on the mass properties of the plurality of balls and the mass properties of the portions of the plurality of rods;
identify, for each ball of the plurality of balls, overlapping portions between pairs of rods that terminate at a respective ball;
estimate, for each ball of the plurality of balls, a mass property for each identified overlapping portion; and
modify the initial estimate of the mass property of the lattice based on the estimation of the mass properties of the overlapping portions to provide a determined mass property of the lattice.

15. The method of claim 1, further comprising:
storing the determined mass property of the lattice in a memory of a data processing system.
